(19) United States
(12) Patent Application Publication
(10) Pub. No.: US 2017/0344433 A1
(43) Pub. Date: Nov. 30, 2017

(54) APPARATUS AND METHOD FOR DATA MIGRATION

(71) Applicant: SAMSUNG SDS CO., LTD., Seoul (KR)

(72) Inventor: Sung-Ho BAE, Seoul (KR)

(73) Assignee: SAMSUNG SDS CO., LTD., Seoul (KR)

(21) Appl. No.: 15/606,701

(22) Filed: May 26, 2017

(30) Foreign Application Priority Data
May 27, 2016 (KR) 10-2016-0065184

(51) Int. Cl. G06F 11/14; G06F 11/20

(52) U.S. Cl. CPC G06F 11/1456; G06F 11/2094; G06F 11/1471; G06F 11/1461; G06F 2201/80; G06F 2212/163

(57) ABSTRACT

Disclosed are a data migration apparatus and method. The data migration apparatus includes a location information acquirer configured to acquire location information corresponding to one or more pieces of migration target data from a first database; a backup data restorer configured to receive backup data of data stored in the first database from a backup device, which stores the backup data, and restore the received backup data; and a data migrator configured to extract the migration target data from the restored backup data by using the acquired location information and migrate the extracted migration target data to a second database.

### CROSS-REFERENCE TO RELATED APPLICATION

This application claims priority to and the benefit of Korean Patent Application No. 10-2016-0065184, filed on May 27, 2016, the disclosure of which is incorporated herein by reference in its entirety.

### BACKGROUND

### 1. Field

Embodiments of the present disclosure relate to a technique for migrating migration target data stored in a database to another database.

### 2. Discussion of Related Art

Along with the recent development of IT technology, the amount of data utilized in various kinds of computing apparatuses is increasing. As the amount of data stored in a database increases, time and resources consumed by a computing apparatus to perform operations also increase. Thus, there is a need for a solution to efficiently manage a large amount of data in a database.

Recently, information lifecycle management (ILM) technology for efficiently managing continuously increasing data has emerged. According to the ILM technology, only information that has not been used for a long time may be separately managed. As an example, the ILM technology is capable of migrating data that is not frequently used to a separate apparatus. It is possible to rapidly search for and utilize data needed by a computing apparatus by removing information that is not frequently used from a database to reduce the amount of data stored in the database.

### SUMMARY

Embodiments of the present disclosure provide efficiently migrating migration target data stored in a database management system.

According to an aspect of the present disclosure, there is provided a data migration apparatus including a location information acquirer configured to acquire location information corresponding to one or more pieces of migration target data from a first database; a backup data restorer configured to receive backup data of data stored in the first database from a backup device, which stores the backup data, and restore the received backup data; and a data migrator configured to extract the migration target data from the restored backup data by using the acquired location information and migrate the extracted migration target data to a second database.

The data migrator may extract migration target data corresponding to each piece of the acquired location information.

The data migrator may extract the migration target data in a text or binary format.

The data migrator may convert the migration target data extracted in the text or binary format into a format corresponding to the second database and migrate the converted migration target data to the second database.

The data migration apparatus may further include a logfile manager configured to acquire a logfile generated for the migration target data from the first database and store the acquired logfile in the second database.

According to another aspect of the present disclosure, there is provided a data migration method performed by a computing apparatus including one or more processors and a memory configured to store one or more programs executed by the one or more processors, the data migration method including acquiring location information corresponding to one or more pieces of migration target data from a first database; receiving backup data of data stored in the first database from a backup device, which stores the backup data, and restoring the received backup data; extracting the migration target data from the restored backup data by using the acquired location information; and migrating the extracted migration target data to a second database.

The extracting of the migration target data may include extracting migration target data corresponding to each piece of the acquired location information.

The extracting of the migration target data may include extracting the migration target data in a text or binary format.

The extracting of the migration target data may include converting the migration target data extracted in the text or binary format into a format corresponding to the second database and migrating the converted migration target data to the second database.

The data migration method may further include acquiring a logfile generated for the migration target data from the first database; and storing the acquired logfile in the second database.

In an exemplary embodiment, there is a data migration apparatus including: at least one processor configured to implement: a location information acquirer configured to acquire location information from a first database, the acquired location information corresponding to migration target data; a backup data restorer configured to receive backup data of original data stored in the first database, from a backup device which stores the backup data, and restore the original data from the received backup data; and a data migrator configured to extract the migration target data from the restored original data by using the acquired location information and move the extracted migration target data to a second database.

Further, the data migrator extracts the migration target data corresponding to the acquired location information. The data migrator extracts the migration target data in a text format or a binary format. The data migrator converts the migration target data extracted in the text or the binary format into a format corresponding to the second database and moves the extracted migration target data to the second database. The at least one processor is further configured to implement a logfile manager configured to acquire a logfile generated for the migration target data from the first database and store the acquired logfile in the second database.

In another exemplary embodiment, there is a data migration method performed by a computing apparatus including one or more processors and a memory configured to store one or more programs executed by the one or more processors, the data migration method including: acquiring location information from a first database, the acquired location information corresponding to migration target data; receiving backup data of original data stored in the first database, from a backup device which stores the backup data, and restoring the original data from the received backup data; extracting the migration target data from the restored original data by using the acquired location information; and moving the extracted migration target data to a second database.

Further, the extracting of the migration target data includes extracting the migration target data corresponding to the acquired location information. The extracting of the migration target data includes extracting the migration target data in a text format or a binary format. The extracting of the migration target data includes converting the migration target data extracted in the text or the binary format into a format corresponding to the second database and wherein the moving the extracted migration target data to the second database including moving the converted migration target data to the second database. Additionally, there is acquiring a logfile generated for the migration target data from the first database; and storing the acquired logfile in the second database.

In yet another exemplary embodiment, there is a non-transitory machine readable medium storing a program which when executed by at least one processor provides instructions for moving data, the instructions including: receiving from a first device, location information corresponding to target data; receiving from a second device, backup data of original data stored in the first device, restoring the original data from the received backup data; extracting the target data from the original data by using the received location information; and storing the extracted target data.

Further, there is obtaining from the first device, a logfile for the target data; and storing the obtained logfile. The logfile is associated with a generation, a modification, or a deletion of the target data in the first device. The logfile is in a text format or a binary format, and wherein the log file is received when the logfile is generated in the first device or is repeatedly received from the first device for every predetermined period of time.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram showing a detailed configuration of a data migration system according to an embodiment of the present disclosure;

FIG. 2 is a block diagram showing a detailed configuration of a data migration apparatus according to an embodiment of the present disclosure;

FIG. 3 is an example diagram showing a process in which a data migration apparatus extracts migration target data using location information according to an embodiment of the present disclosure;

FIG. 4 is a flowchart illustrating a data migration method according to an embodiment of the present disclosure; and

FIG. 5 is a block diagram illustrating a computing environment including a computing apparatus that is suitable to be used according to example embodiments.

### DETAILED DESCRIPTION OF EXEMPLARY EMBODIMENTS

Hereinafter, embodiments of the present disclosure will be described in detail with reference to the accompanying drawings. The following detailed description is provided to assist the reader in gaining a comprehensive understanding of the methods, apparatuses, and/or systems described herein. However, the description is only an example, and the present disclosure is not limited thereto.

In describing embodiments of the present disclosure, when it is determined that a detailed description of a known technique associated with the present disclosure would unnecessarily obscure the subject matter of the present disclosure, the detailed description thereof will be omitted. Also, terms used herein are defined in consideration of the functions of the present disclosure and may be changed depending on a user, an intent of an operator, or a custom. Accordingly, the terms must be defined based on the following overall description of this specification. The terminology used herein is only for the purpose of describing embodiments of the present disclosure and is not restrictive. The singular forms “a,” “an,” and “the” are intended to include the plural forms as well, unless the context clearly indicates otherwise. It should be understood that the terms “comprises,” “comprising,” “includes,” and/or “including” specify the presence of stated features, integers, steps, operations, elements, and/or components when used herein, but do not preclude the presence or addition of one or more other features, integers, steps, operations, elements, components, and/or groups thereof.

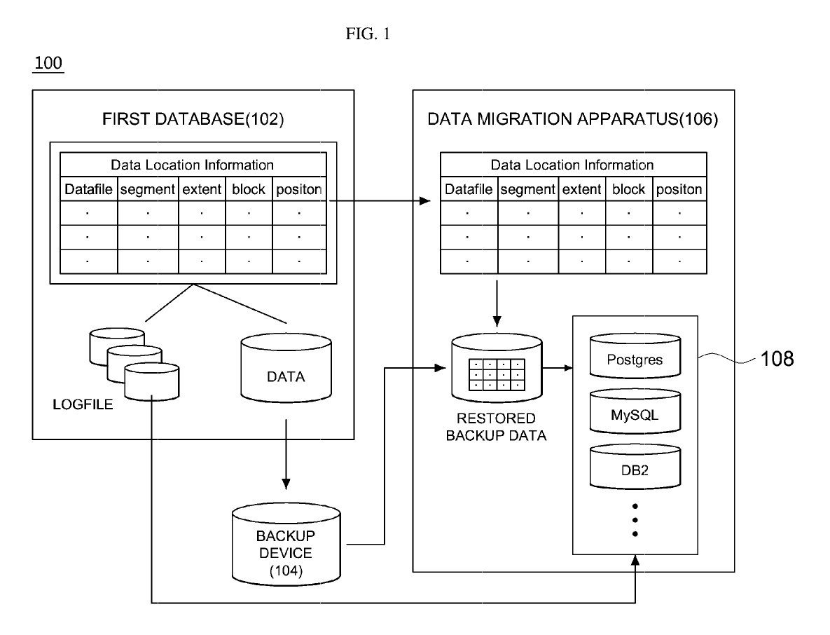

FIG. 1 is a block diagram showing a detailed configuration of a data migration system 100 according to an embodiment of the present disclosure. As shown in FIG. 1, the data migration system 100 according to an embodiment of the present disclosure may include a first database 102, a backup device 104, and a data migration apparatus 106.

The first database 102 is a database in which migration target data is stored. The first database 102 according to an embodiment of the present disclosure does not include only a database in which data is simply stored and may be a database management system (DBMS) that is operated to manage the database and provide an environment in which a plurality of application programs may share and use data stored in the database. That is, the first database 102 may receive instructions associated with an input, output, etc. of data and perform tasks corresponding thereto. Here, the database denotes a collection of data obtained by organizationally integrating and structuring associated data.

The first database 102 may receive information regarding the migration target data among data that is stored therein. Specifically, the first database 102 may receive a data migration policy that is set by an administrator. For example, the data migration policy may include a policy of migrating data that has been stored for a specific period (e.g., 5 years) or longer from a writing day thereof or data that has not been used for a certain period (e.g., 3 months) or longer.

The first database 102 may search for the migration target data according to the data migration policy. Also, the first database 102 may search for location information regarding the migration target data, and may transmit the location information regarding the migration target data to the data migration apparatus 106, which will be described below. According to an embodiment, the first database 102 that is being operated does not directly migrate the migration target data and may search for only the location information regarding the migration target data and transmit the location information to the data migration apparatus 106. Thus, it is possible to minimize use of a memory of the first database 102 that is used by a migration procedure and prevent performance degradation of the first database 102 caused by the migration procedure.

The backup device 104 generates a copy of original data in preparation for a loss of or damage to the data. The backup device 104 may back up the data stored in the first database 102 (hereinafter referred to as backup data). Also, the backup device 104 may store the backup data in a storage device provided therein. According to an embodiment, the backup device 104 may back up the data according to a backup policy that is set by an administrator. Here, the backup policy may include information regarding a backup period, data to be back up, etc. For example, the backup device 104 may perform backup every predetermined period of time (e.g., 24 hours or 48 hours). Also, the backup device 104 may be configured to back up all the data stored in the first database every predetermined backup period of time or back up only data changed after a previous backup.

The data migration apparatus 106 is a module for migrating the migration target data stored in the first database 102 to a second database 108. According to an embodiment, the data migration apparatus 106 may extract the migration target data by using the location information that is acquired from the first database 102 and the backup data that is received from the backup device 104 and then restored.

Here, the second database 108 is a database for storing the migration target data, and may be a data storage space distinct from the first database 102. For example, the second database 108 and the first database 102 may be configured with different hardware or provided in different places. Like the first database 102, the second database 108 may just be a database in which data is stored. Also, the second database 108 may be loosely understood as a system for managing the database.

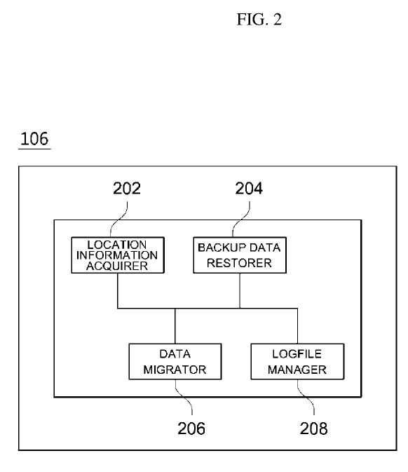

FIG. 1 shows that the second database 108 is included in the data migration apparatus 106, but this is merely an example to facilitate understanding. The second database 108 may be configured as a different element from the data migration apparatus 106. A detailed configuration of the data migration apparatus 106 will be described in detail with reference to FIG. 2.

FIG. 2 is a block diagram showing the detailed configuration of the data migration apparatus 106 according to an embodiment of the present disclosure. As shown in FIG. 1, the data migration apparatus 106 according to an embodiment of the present disclosure may include a location information acquirer 202, a backup data restorer 204, a data migrator 206, and a logfile manager 208.

The location information acquirer 202 is a module for acquiring location information of migration target data. The location information acquirer 202 may acquire location information corresponding to the migration target data stored in the first database 102, which is being operated. In detail, the location information acquirer 202 may acquire only the location information of the migration target data, rather than the migration target data itself, from the first database 102. According to an embodiment, the location information may be configured differently depending on the type of the first database 102. For example, the location information may be configured with a datafile number, a segment number, an extent number, a block number, etc. Here, a datafile, a segment, an extent, a block, etc. may be logical spaces constituting a database. As an example, a datafile may include a plurality of segments, a segment may include a plurality of extents, and an extent may include a plurality of blocks.

The backup data restorer 204 may restore the backup data of the data stored in the first database 102. In detail, the backup data restorer 204 may receive and restore the backup data that is backed up by the backup device 104. Here, the backup data may be a datafile in which all of the data stored in the first database 102 is backed up, and may also be a datafile in which migration target data is backed up according to an administrator's settings. Backup data restoration denotes that the data migration apparatus 106 restores backup data so that the backup data may be available. For example, when the backup data is a compressed version of an original data stored in the first database 102, the backup data restorer 204 may restore the backup data to the original data by uncompressing the backup data. Thus, the data migrator 206 may search for and extract the migration target data from the restored backup data.

The data migrator 206 may use the location information acquired from the first database 102 to extract the migration target data from the restored backup data. In detail, the data migrator 206 may sequentially extract data corresponding to each unit constituting the location information from the restored backup data. For example, first, the data migrator 206 may extract an area corresponding to a datafile number, which is one piece of the location information, from the restored backup data and then sequentially extract areas corresponding to a segment number, an extent number, and a block number. As a result, the data migrator 206 may extract data included in the area corresponding to the block number as the migration target data.

According to an embodiment, the data migrator 206 may extract migration target data corresponding to each piece of the acquired location information. In detail, the data migrator 206 may acquire one or more pieces of the location information and may extract the migration target data corresponding to each of the pieces of the location information in a predetermined order.

When an error occurs during the extraction of the migration target data, the data migrator 206 may re-extract the corresponding migration target data beginning with location information in which the error occurred. Here, the error occurring during the extraction of the migration target data may denote that the data migrator 206 did not acquire a result value for the corresponding migration target data although the data migrator 206 attempted to extract the migration target data by using the location information. In this case, the data migrator 206 may perform re-extraction beginning with the migration target data corresponding to the location information in which the error occurred without needing to extract the migration target data from the beginning again.

The data migrator 206 may migrate the extracted migration target data to the second database 108. The second database 108 is a data storage space distinct from the first database 102, and may store the migration target data.

According to an embodiment, the data migrator 206 may extract migration target data in a text or binary format. Here, the binary format may be a data format in which data is represented in binary. Also, the data migrator 206 may convert the extracted migration target data from the text or binary format to a format corresponding to the kind and type of the second database 108 and store the converted migration target data. Thus, the data migrator 206 may store the migration target data regardless of the kind and type of the second database 108. In other words, the second database 108 does not need to have the same kind or type as the first database 102.

According to an embodiment, the logfile manager 208 may acquire a logfile generated for the migration target data from the first database 102. According to an embodiment of the present disclosure, the logfile may be a file in which a message associated with generation, modification, or deletion of the migration target data is recorded. Subsequently, the logfile manager 208 may extract data of the first database 102 added by a user from the acquired logfile in a text or binary format and store the extracted data in the second database 108. For example, the logfile manager 208 may extract data of the logfile in the text or binary format and store the extracted data in the second database 108 every predetermined period of time (e.g., 12 hours or 24 hours) or whenever a logfile is generated. The logfile manager 208 continuously extracts and stores data of a logfile corresponding to the migration target data stored in the second database 108, and thus it is possible to implement a function of automatically migrating data and also to easily recover a system from a fault associated with the migration target data when the fault is generated.

The first database 102 provides only location information of migration target data, and thus it is possible to minimize use of a memory of the first database 102 that is accompanied by the migration procedure. Thus, it is possible to prevent performance of the first database 102 that is being operated from being degraded by the migration procedure.

It should be noted that the data migration apparatus 106 according to an embodiment of the present disclosure does not need to be configured as one physical apparatus and may be configured with one or more physical apparatuses.

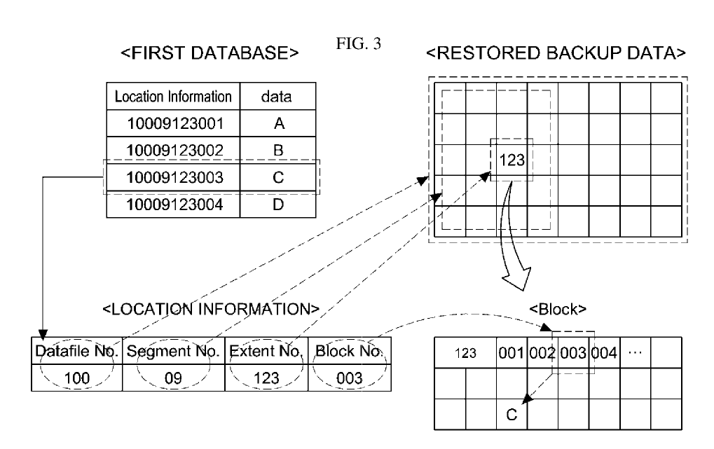

FIG. 3 is an example diagram showing a process in which the data migration apparatus 106 extracts migration target data using location information according to an embodiment of the present disclosure.

According to an embodiment, the location information acquired from the first database 102 may be configured differently depending on the kind of the first database 102. For example, the location information may be 10009123003, and may be configured with a datafile number 100, a segment number 09, an extent number 123, and a block number 003.

Referring to FIG. 3, data of the first database 102 may be stored in the form of a table along with its corresponding location information. The first database 102 may search for location information of a desired piece of stored data. As an example, the first database 102 may determine data C from among the stored data as the migration target data according to a predetermined data migration policy. Subsequently, the first database 102 may search for location information of the data C and transmit 10009123003 to the data migration apparatus 106 as the location information.

The data migration apparatus 106 may restore backup data. As described above, the backup device 104 may back up the data stored in the first database 102. Here, the data backed up by the backup device 104 may be all datafiles stored in the first database 102 and may also be set to include only a migration target datafile according to an administrator's settings.

The data migration apparatus 106 may use the location information of the migration target data to extract the migration target data from the restored backup data. Referring to FIG. 3, first, the data migration apparatus 106 may detect a data area corresponding to the datafile number 100 of the location information from the restored backup data. Next, the data migration apparatus 106 may detect an area corresponding to the segment number 09 in the area corresponding to the datafile number 100. Next, the data migration apparatus 106 may detect an area corresponding to the extent number 123 in the area corresponding to the segment number 09. Last, the data migration apparatus 106 may detect an area corresponding to the block number 003 in the area corresponding to the extent number 123. As a result, the data migration apparatus 106 may detect the data C included in the area corresponding to the block number 003. Subsequently, the data migration apparatus 106 may migrate the detected migration target data to the second database 108.

Since the data migration apparatus 106 extracts migration target data for each piece of the location information, it is possible to resume a task beginning with location information in which an error occurred although the error has occurred during the data extraction. Thus, time and resources consumed for the task may be saved.

It should be noted that the method of extracting data using location information is not limited to the aforementioned example, and various well-known algorithms may be used instead of the aforementioned example.

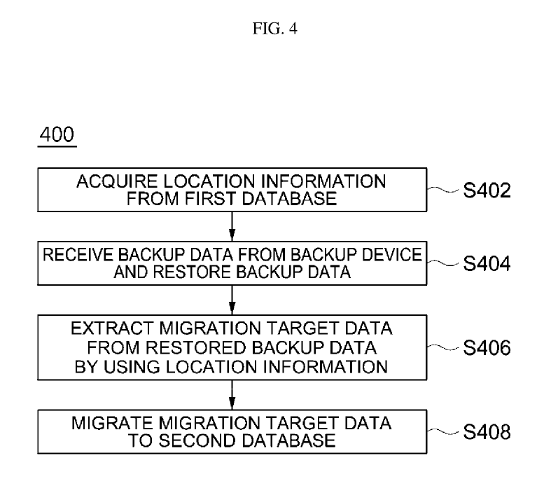

FIG. 4 is a flowchart illustrating a data migration method 400 according to an embodiment of the present disclosure. The method shown in FIG. 4 may be performed by the above-described data migration apparatus 106. In the shown flowchart, the method is described as having a plurality of steps. However, at least some of the steps may be performed in an exchanged order, performed in combination with another step, omitted, divided into sub-steps, or performed in addition to one or more steps that are not shown.

First, the location information acquirer 202 may acquire location information corresponding to migration target data from the first database 102, which is being operated (S402). To this end, the first database 102 may select the migration target data from among data stored therein according to a predetermined data migration policy and transmit the location information of the migration target data to the location information acquirer 202.

Next, the backup data restorer 204 may receive backup data of the data stored in the first database from the backup device 104, which stores the backup data, and may restore the received backup data (S404). To this end, the backup device 104 may back up the data stored in the first database 102 every predetermined period of time. The backup data restorer 204 may restore the backup data to an available form.

Next, the data migrator 206 may extract the migration target data from the restored backup data by using the acquired location information (S406). As described above, the data migrator 206 may extract migration target data corresponding to each piece of the location information. Also, when an error occurs during the extraction of the migration target data, the data migrator 206 may re-extract the corresponding migration target data beginning with the location information in which the error occurred.

Next, the data migrator 206 may migrate the extracted migration target data to the second database 108 (S408). According to an embodiment, the data migrator 206 may extract the migration target data in a text or binary format, convert the extracted migration target data into a format corresponding to the second database 108, and store the converted migration target data.

The logfile manager 208 may receive a logfile associated with the migration target data from the first database 102, extract data from the received logfile in a text or binary format, and store the extracted data in the second database 108. The logfile manager 208 automatically extracts data of the first database 102 corresponding to the migration target data stored in the second database 108 and stores the extracted data in the second database 108, and thus it is possible to implement a function of automatically migrating data and also easily recovering a system from a fault associated with the migration target data when the fault is generated.

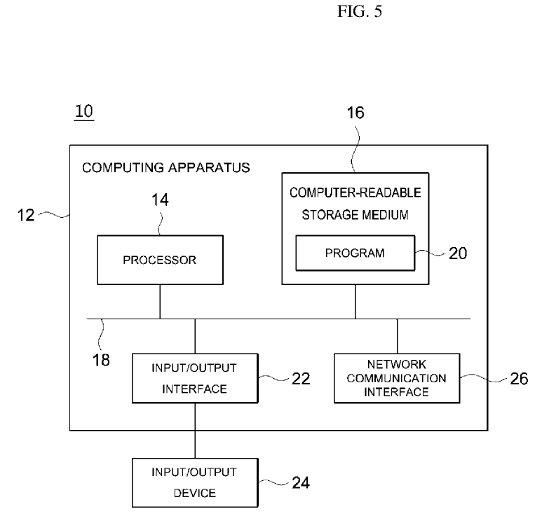

FIG. 5 is a block diagram illustrating a computing environment 10 including a computing device that is suitable to be used according to example embodiments. In the shown embodiment, each component may have a function and capability that differs from the following description, and an additional component may be included in addition to those in the following description.

The computing environment 10 includes a computing apparatus 12. According to an embodiment, the computing apparatus 12 may be the first database 102. Also, the computing apparatus 12 may be the backup device 104. Also, the computing apparatus 12 may be the data migration apparatus 106. The computing apparatus 12 includes at least one processor 14, a computer-readable storage medium 16, and a communication bus 18. The processor 14 may enable the computing apparatus 12 to operate according to the aforementioned example embodiment. For example, the processor 14 may execute one or more programs stored in the computer-readable storage medium 16. The one or more programs may include one or more computer executable instructions which may be configured to enable the computing apparatus 12 to perform operations according to an example embodiment when they are executed by the processor 14.

The computer-readable storage medium 16 is configured to store computer-executable instructions, program codes, program data, and/or other suitable forms of information. The program 20 stored in the computer-readable storage medium 16 includes a set of instructions that are executable by the processor 14. In an embodiment, the computer-readable storage medium 16 may be a memory (a volatile memory such as a random access memory, a non-volatile memory, or an appropriate combination thereof), one or more magnetic disk storage devices, optical disk storage devices, flash memory devices, other forms of storage media that may be accessed by the computing apparatus 12 and are configured to store desired information, or a suitable combination thereof.

The communication bus 18 connects the processor 14, the computer-readable storage medium 16, and other various components of the computing apparatus 12 to one another.

The computing apparatus 12 may also include one or more input/output interfaces 22 that provide an interface for one or more input/output devices 24 and one or more network communication interfaces 26. The input/output interfaces 22 and the network communication interfaces 26 are connected to the communication bus 18. The input/output devices 24 may be connected to other components of the computing apparatus 12 through the input/output interfaces 22. For example, the input/output devices 24 may include input devices such as a pointing device (a mouse or a track pad), a keyboard, a touch input device (a touch pad or a touch screen), a voice or sound input device, and various kinds of sensor devices, photographing devices, and/or output devices, such as a display device, a printer, a speaker, and/or a network card. For example, the input/output devices 24 may be included in the computing apparatus 12 as components that form the computing apparatus 12, and may be connected to the computing apparatus 12 as separate devices distinct from the computing apparatus 12.

According to embodiments of the present disclosure, the first database provides only location information of migration target data, and thus it is possible to minimize use of a memory of the first database that is accompanied by the migration procedure. Accordingly, performance of the first database that is being operated can be prevented from being degraded by the migration procedure.

Also, according to embodiments of the present disclosure, the data migration apparatus extracts migration target data in a text or binary format, converts the migration target data extracted in the text or binary format into a format corresponding to the second database, and stores the converted migration target data, and thus it is possible to flexibly migrate the migration target data regardless of the type of the second database.

Also, according to embodiments of the present disclosure, the data migration apparatus extracts the migration target data for each piece of the location information, and thus it is possible to resume a task beginning with location information in which an error occurred although the error has occurred during the data extraction. Accordingly, time and resources consumed for the task can be saved.

Although example embodiments of the present disclosure have been described in detail, it should be understood by those skilled in the art that various changes may be made without departing from the spirit or scope of the present disclosure. Thus, the scope of the present disclosure is to be determined by the following claims and their equivalents, and is not restricted or limited by the foregoing detailed description.

What is claimed is:

1. A data migration apparatus comprising:
at least one processor configured to implement:
a location information acquirer configured to acquire location information from a first database, the acquired location information corresponding to migration target data;
a backup data restorer configured to receive backup data of original data stored in the first database, from a backup device which stores the backup data, and restore the original data from the received backup data; and
a data migrator configured to extract the migration target data from the restored original data by using the acquired location information and move the extracted migration target data to a second database.

2. The data migration apparatus of claim 1, wherein the data migrator extracts the migration target data corresponding to the acquired location information.

3. The data migration apparatus of claim 1, wherein the data migrator extracts the migration target data in a text format or a binary format.

4. The data migration apparatus of claim 3, wherein the data migrator converts the migration target data extracted in the text or the binary format into a format corresponding to the second database and moves the extracted migration target data to the second database.

5. The data migration apparatus of claim 1, wherein the at least one processor is further configured to implement a logfile manager configured to acquire a logfile generated for the migration target data from the first database and store the acquired logfile in the second database.

6. A data migration method performed by a computing apparatus including one or more processors and a memory configured to store one or more programs executed by the one or more processors, the data migration method comprising:
acquiring location information from a first database, the acquired location information corresponding to migration target data;
receiving backup data of original data stored in the first database, from a backup device which stores the backup data, and restoring the original data from the received backup data;
extracting the migration target data from the restored original data by using the acquired location information; and
moving the extracted migration target data to a second database.

7. The data migration method of claim 6, wherein the extracting of the migration target data comprises extracting the migration target data corresponding to the acquired location information.

8. The data migration method of claim 6, wherein the extracting of the migration target data comprises extracting the migration target data in a text format or a binary format.

9. The data migration method of claim 8, wherein the extracting of the migration target data comprises converting the migration target data extracted in the text or the binary format into a format corresponding to the second database and
wherein the moving the extracted migration target data to the second database comprising moving the converted migration target data to the second database.

10. The data migration method of claim 6, further comprising:
acquiring a logfile generated for the migration target data from the first database; and
storing the acquired logfile in the second database.

11. A non-transitory machine readable medium storing a program which when executed by at least one processor provides instructions for moving data, the instructions comprising:
receiving from a first device, location information corresponding to target data;
receiving from a second device, backup data of original data stored in the first device,
restoring the original data from the received backup data;
extracting the target data from the original data by using the received location information; and
storing the extracted target data.

12. The non-transitory machine readable medium of claim 11, further comprising:
obtaining from the first device, a logfile for the target data; and
storing the obtained logfile.

13. The non-transitory machine readable medium of claim 12, wherein the logfile is associated with a generation, a modification, or a deletion of the target data in the first device.

14. The non-transitory machine readable medium of claim 13, wherein the logfile is in a text format or a binary format, and
wherein the log file is received when the logfile is generated in the first device or is repeatedly received from the first device for every predetermined period of time.
